(19) United States
(12) Patent Application Publication
(10) Pub. No.: US 2006/0140395 A1
(43) Pub. Date: Jun. 29, 2006

(54) Method for assembling clip for electronic device retainer and connecting structure of the clip

(75) Inventor: Dong Joo Kim, Seoul (KR)

Correspondence Address: JENKENS & GILCHRIST, P.C., 901 15TH STREET N.W., SUITE 900, WASHINGTON, DC, 20005, US

(73) Assignee: Joong Ang P & S, CO., Ltd., Seoul (KR)

(21) Appl. No.: 11/315,346

(22) Filed: Dec. 23, 2005

(30) Foreign Application Priority Data
Dec. 24, 2004 (KR) 10-2004-0112252

(51) Int. Cl. H04M 1/00

(52) U.S. Cl. 379/428.01

(57) ABSTRACT

A method for assembling a clip for a mobile phone retainer having a slider connection, the clip including a top plate and a bottom plate including fitting a clip retaining member into a through hole formed at the center of the bottom plate of the clip, fitting insertion protrusions of a slider plate to corresponding insertion holes of the clip retaining member, welding the slider and clip retaining member together while the insertion protrusions are fitted into the insertion holes, and connecting the top plate of the clip to the bottom plate using a hinge.

This application claims the benefit of the Korean Patent Application No. P2004-0112252, filed on Dec. 24, 2004, which is hereby incorporated by reference in its entirety.

### BACKGROUND OF THE INVENTION

1. Field of the Invention

The present invention relates to clip for an electronic device retainer, and more particularly, to a method for assembling a clip for an electronic device retainer and a connecting structure of the clip. Although the present invention is suitable for a wide scope of applications, it is particularly suitable for affixing a clip to a personal electronic device retainer so that the clip can be rotated at a variety of angles and still be detachable from the personal electronic device retainer.

2. Discussion of the Related Art

Generally, a clip for a mobile phone is affixed to a rear surface of a mobile phone retainer, such as a case or holder. The clip is used in such a manner that the mobile phone retainer can be hung on a belt, which a user wears, so as to secure the mobile phone to the user. Hereinafter, a related art case for retaining a mobile phone will be described.

A related art case for holding a mobile cell phone holder is disclosed in the Korean Registered Model No. 20-0262088 entitled “Case for Mobile Phone.” FIG. 1 illustrates a related art case for a mobile phone having a rotatably affixed clip. This related art clip can be rotated in an indexing fashion with a clicking sound such that the angle of the clip with respect to the case can be controlled.

As shown in FIG. 1, the related art case has a clip including an engagement member 20, a bottom plate 30, a clip retaining member 40, and a top plate 50. The related art case has a main body 1 with a key protrusion 2 and a toothed member 4. The key protrusion 2 maintains the alignment of the main body 1 and the clip retaining member 40. The main body 1, the key protrusion 2 and the toothed member 4 can be manufactured in various shapes. Preferably, as shown in FIG. 1, the key protrusion 2 has a slot-line shape while the toothed member 4 has teeth with a curved triangular shape.

The engagement member 20 shown in FIG. 1 is provided between the main body 1 and the bottom plate 30, and has a ring shape. The engagement member 20 includes a circular toothed spring 22 with a rectangular plate section 24. The toothed spring 22 is positioned to correspond to the toothed member 4 of the main body 1. The rectangular plate section 24 is at an upper portion of the engagement member 20 and positioned over an alignment tab on the bottom plate 30 to maintain its rotational position with respect to the bottom plate 30.

If a user rotates the main body 1 shown in FIG. 1, a clicking sound is generated when the toothed spring 22 and the toothed member 4 are rotated across each other. Thus, a user can exactly control a rotational angle of the main body 1 and at the same time surmise the rotational angle after hearing the number of “clicks” in the clicking sound.

The related art case for the mobile phone shown in FIG. 1 has several problems. The toothed member 4 of the main body 1 is in surface-contact with the toothed spring 22 of the engagement member 20. Friction occurs due to the surface-contact. Thus, either one of or both the toothed spring 22 and the toothed member 4 can become worn due to such friction so that eventually the indexing function will be lost. Mechanical instability or unreliability can later occur since the toothed member 4 or the engagement member 20 can be easily damaged. Moreover, since the main body 1 and the engagement member 20 both act like plate springs in their operation, the elastic forces created between them in their operation are counter to each other's elastic state of rest, which can cause one of them to fail in that one bends so as to no longer cause a force against the other.

To solve the aforementioned problems, other related art cases for mobile phones have been suggested. FIG. 2 illustrates a related art holder for a mobile phone having a rotatably affixed clip. FIG. 3 illustrates another related art case for a mobile phone having a rotatably affixed clip.

The related art holder shown in FIG. 2 has a shape for holstering the mobile phone. The related art holder of FIG. 2 includes a main body 110 of either soft material, such as leather, or hard material, such as plastic. The related art case of FIG. 3 includes a main body 100 of a hard material, such as plastic, the snaps on to the mobile phone.

The related art shown in FIGS. 2 and 3 both have a bottom plate 300 provided with a through hole 301 having teeth 304. The teeth 304 are formed on an inner circumference of the through hole 301. Both of the related art holders shown in FIGS. 2 and 3 also include a clip retaining member 400 and a top plate 500. The clip retaining member 400 is inserted into the through hole 301 of the bottom plate 300 and is permanently attached to the main body 110 in FIG. 2 or to the main body 100 in FIG. 3. The top plate 500 is affixed to the bottom plate 300 by a hinge with an elastic device that applies force to close the hinge. The bottom plate 300 and the top plate 500 constitute a clip affixed to the main body 100 by the clip retaining member 400.

The clip retaining member 400 is provided with a ratchet pall 405. The ratchet pall 405 can be elongated and protracted into contact with the toothed groove 304 by a coil spring 404 such that clip retaining member is indexed to correspond to the toothed grooves 304 of the through hole 301. Thus, when both the bottom plate 300 and the top plate 500, are affixed to the main body 100 of the case via the clip retaining member 400, the spring-loaded ratchet pall 405 is in surface-contact along the toothed groove 304 of the through hole 301 as the clip rotates. Accordingly, the clip can be smoothly indexed as it is rotated.

A frictional sound, such as click, is generated by rotation of the clips shown in FIGS. 1-3 so that a user who wears the mobile phone holder can sense the rotational range of the clip. The related art case 10 is made of a tough resin that is slick so as to prevent the engagement member 20 or the toothed member 14 of FIG. 1 from being worn or easily damaged. The use of the spring-loaded ratchet pall 405 in the related art provides for a long life indexing mechanism.

The related art shown in FIGS. 1-3 have a problem in that the clip cannot be detached from the case or holder once the clip is affixed to the main body of a case or holder. This is because the clip retaining member is permanently affixed to the case or holder for a mobile phone with an adhesive or some other type of permanent bonding technique. Thus, if structural elements constituting the clip and its connecting structure are covered with dust, it is difficult to clean them. Also, if a part of the clip or its connecting structure is damaged, it can not be easily replaced with another one.

### SUMMARY OF THE INVENTION

Accordingly, the present invention is directed to a method for assembling a clip of a case for an electronic device retainer and a connecting structure of the clip, which substantially obviate one or more problems due to limitations and disadvantages of the related art.

An object of the present invention is to provide a method for assembling a clip for an electronic retainer and a connecting structure of the clip that can be used with a different types of mobile phone cases and mobile phone holders.

Another object of the present invention is to provide a method for assembling a clip for an electronic retainer and a connecting structure of the clip such that the clip is detachably affixed and be rotated to a variety of angles.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for assembling a clip for a mobile phone retainer having a slider connection, the clip including a top plate and a bottom plate including fitting a clip retaining member into a through hole formed at the center of the bottom plate of the clip, fitting insertion protrusions of a slider plate to corresponding insertion holes of the clip retaining member, welding the slider and clip retaining member together while the insertion protrusions are fitted into the insertion holes, and connecting the top plate of the clip to the bottom plate using a hinge.

In another aspect, a connecting structure for an electronic device retainer phone includes a clip having a bottom plate having a hole therethrough with grooved teeth about the circumference thereof and top plate attached to the bottom plate by a hinge, a slider connection permanently attached to the electronic device retainer, wherein the slider connection includes a pair of slider racks with a limit stop at one side of and between the pair of slider racks and a backstopper provided at another side of the pair of slider racks opposite to the limit edge, a slider having a slider plate that fits into the slider rack of the slider connection, and a clip retaining member with a spring-loaded pall in contact with the grooved teeth of the bottom plate and attached to the slider plate for connecting a clip to the mobile phone retainer such that the clip can be rotated in an indexing manner.

In another aspect, a connecting structure for an electronic device retainer phone includes a clip having a bottom plate with a guide groove and top plate attached to the bottom plate by a hinge, a slider connection permanently attached to the electronic device retainer, wherein the slider connection includes a pair of slider racks with a limit stop at one side of and between the pair of slider racks and a backstopper provided at another side of the pair of slider racks opposite to the limit stop, a slider having a slider plate that fits into the slider rack of the slider connection, and a clip retaining member having a rim edge for insertion into the guide groove of the bottom plate.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a related art case for a mobile phone having a rotatably affixed clip;

FIG. 2 illustrates a related art holder for a case of a mobile phone having a rotatably affixed clip;

FIG. 3 illustrates another related art case for a mobile phone having a rotatably affixed clip;

FIG. 4 illustrates a slider connection according to an embodiment of the present invention;

FIG. 5 is an exploded perspective view illustrating a connecting structure of a clip affixed to a case for a mobile phone in accordance with an embodiment of the present invention;

FIG. 6 illustrates another connecting structure of a clip affixed to a leather holder for a mobile phone in accordance with an embodiment of the present invention;

FIG. 7 illustrates another connecting structure of a clip affixed to a case for a mobile phone in accordance with an embodiment of the present invention;

FIG. 8 is a side view illustrating a slider connecting structure integrated into a case for a mobile phone in accordance with an embodiment of the present invention;

FIG. 9 is a rear view of the case in FIG. 8;

FIG. 10 illustrates a plan, front and side view of a slider plate in accordance with an embodiment of the present invention;

FIG. 11 illustrates a clip retaining member of the present invention, viewed from side and rear surface;

FIG. 12 illustrates a cross-sectional and plan view of a ratchet pall and spring for a click portion in accordance with embodiments of the present invention;

FIG. 13 is a side view illustrating a clip in accordance with an embodiment of the present invention affixed to a case for a mobile phone;

FIG. 14 is a rear view of a clip in accordance with an embodiment of the present invention affixed to a case for a mobile phone;

FIG. 15 is a cross-sectional view illustrating the operational of a click portion according embodiments of the present invention;

FIG. 16 illustrates a ratchet pall positioned in a teeth groove in accordance with an embodiment of the present invention; and

FIG. 17 illustrates a ratchet pall positioned in between teeth grooves in accordance with an embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

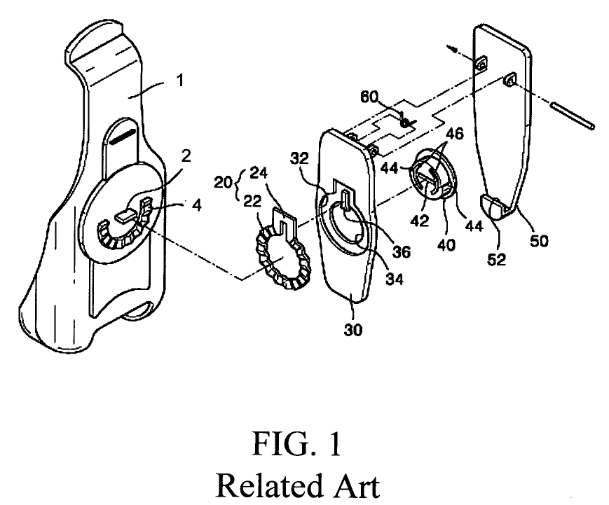

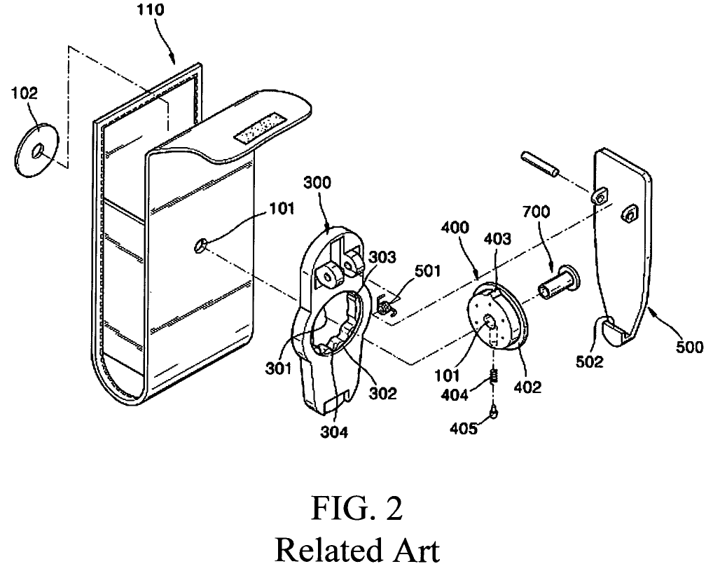

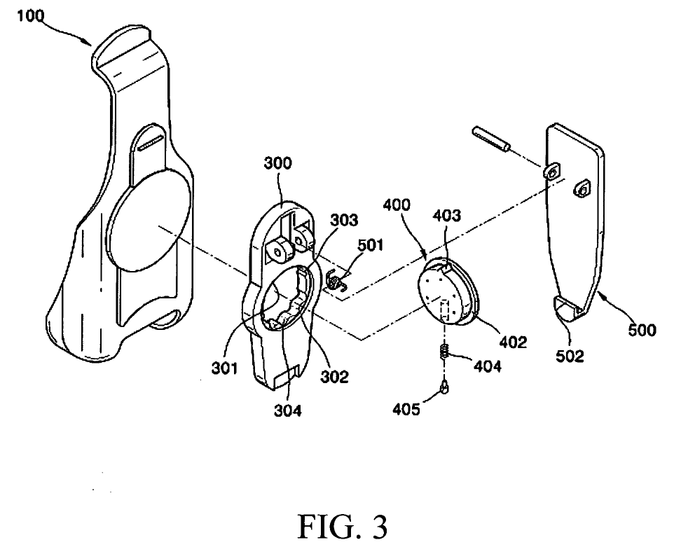

In embodiments of the present invention, a top plate of a clip is detachably attached to a bottom plate via a spring closing hinge and the clip is affixed to a personal electronic device (i.e., mobile phone) retainer through a clip retaining member fitted into a through hole formed in the bottom plate. Unlike the related art of FIGS. 1-3, the clip retaining member in embodiments of the present invention is not permanently attached to the personal electronic device retainer. The clip along with the clip retaining member can be detached from the mobile phone retainer such that the clip can be used with any one of a variety of personal electronic device retainers.

For better understanding of the present invention, a connecting structure of a clip according to embodiments of the present invention will be described along with its operation. It is noted that a connecting structure of a clip to a personal electronic device retainer according to the present invention has various embodiments.

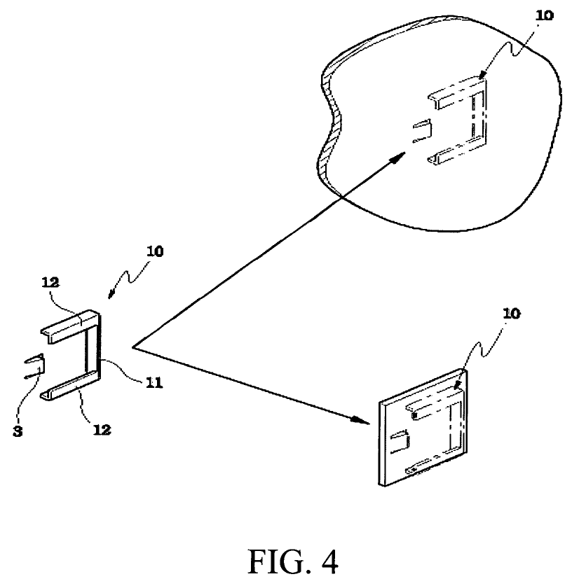

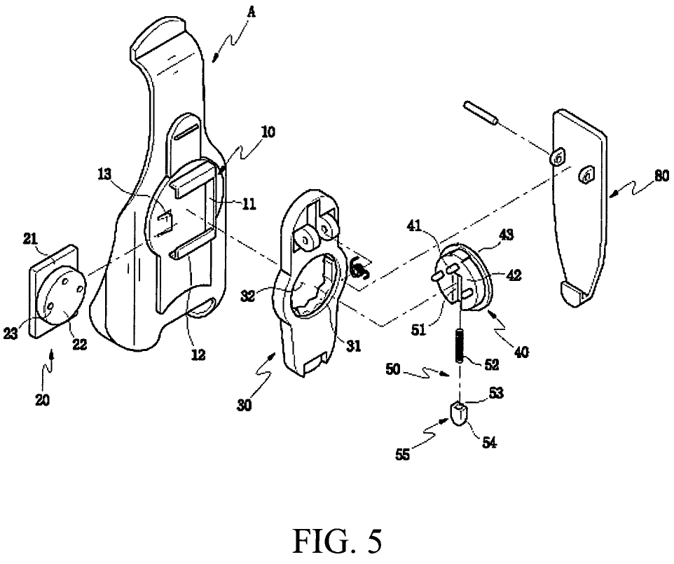

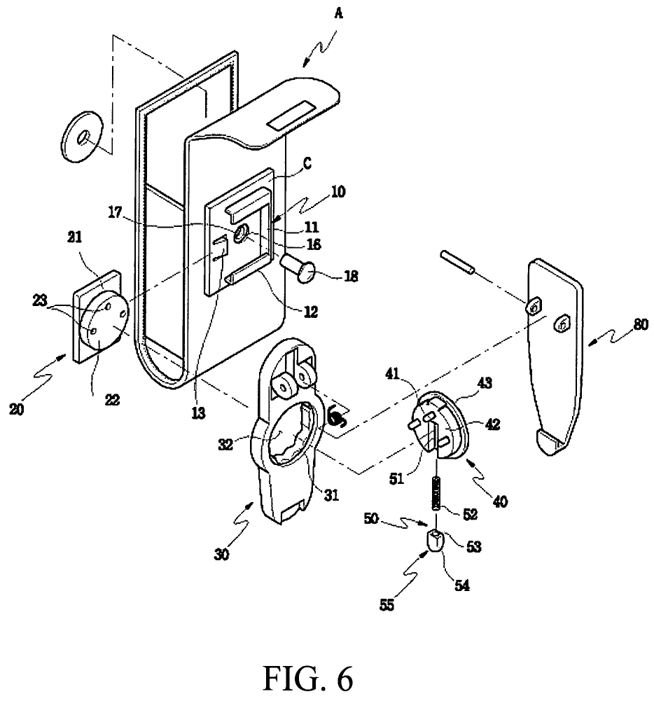

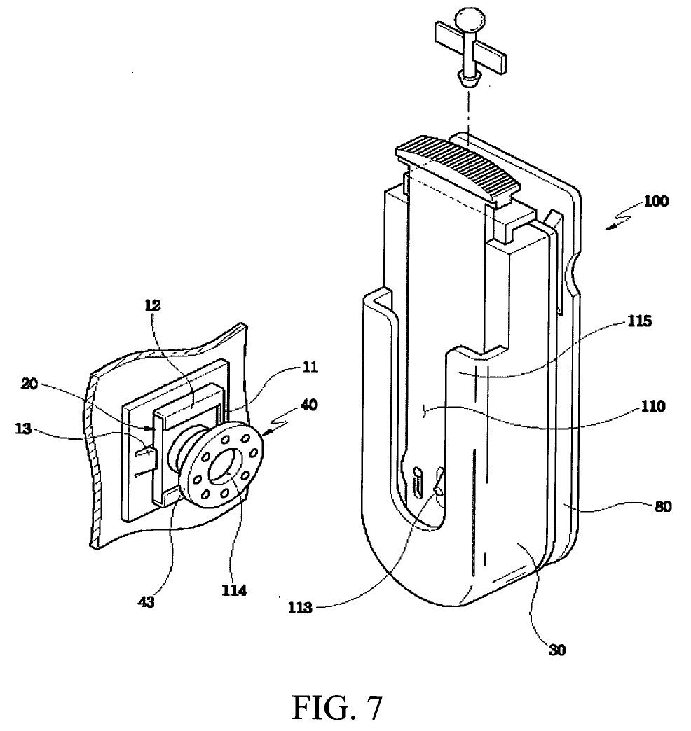

FIG. 4 illustrates a slider connection according to an embodiment of the present invention. FIG. 5 is an exploded perspective view illustrating a connecting structure of a clip affixed to a case for a mobile phone in accordance with an embodiment of the present invention. FIG. 6 illustrates another connecting structure of a clip affixed to a leather holder for a mobile phone in accordance with an embodiment of the present invention. FIG. 7 illustrates another connecting structure of a clip affixed to a case for a mobile phone in accordance with an embodiment of the present invention.

As shown in FIGS. 4-7, a slider connection 10 according to embodiments of the present invention includes a pair of slider racks 12 with a limit stop 11 at one side of and between the pair of slider racks. The edges of the pair of slider racks 12 are bent over toward each other. The limit stop 11 can also have an edge bent over toward the backstopper or straight. A backstopper 13 is provided at an other side of the pair of slider racks 12 opposite to the limit stop 11. The backstopper 13 is an elastic protrusion. As shown in FIG. 4, the slider rack 12, the limit stop 11 and the backstopper 13 of a slider connection can either be an integral part of a mobile phone retainer or a plate permanently attached to the mobile phone retainer.

As shown in FIGS. 5 and 6, a slider 20 includes a slider plate 21 that can be fitted into the slider rack 12 of the slider connecting structure, a circular plate 22 protruding from a center portion of the slider plate 21, and insertion holes 23 at a front surface of the circular plate 22. As also shown in FIGS. 5 and 6, a clamp retaining member 40 includes a circular plate 42, a spring-loaded pall 50, and a rim edge 43. The circular plate 42 is inserted into a through hole 32 formed in the bottom plate 30, and has insertion protrusions 41 on its surface. The through hole 32 has a toothed groove 31. A spring-loaded ratchet pall 50 controls rotation of the clip 100. The rim edge 43 is formed with a diameter greater than that of the circular plate 42 integral with the circular plate 42. The bottom plate 30 of the clip is connected to the slider 20 through the clip retaining member 40.

The clip 100 shown in FIG. 7 of an embodiment of the present invention can be fixed to various products by the connecting structure. The clip shown in FIG. 7 is provided in such a manner that the clip retaining member 40 of the slider are pushed into a guide groove 110. The guide groove 110 is formed on a rear surface of the bottom plate 30, and is partially opened. In this case, a stopper opening 114 is provided at the center of the rim edge 43 of the clip retaining member 40 so that a latch 113 in the guide groove 110 of the bottom plate 30 can be latched into the stopper opening 114. Also, a guide plate 115 is provided to prevent the rim edge 43 of the clip retaining member 40 from coming out of the guide groove 110. Of course, the rim edge 43 can be released from the groove 114 through the latch 113 if a release button, as shown, is pushed.

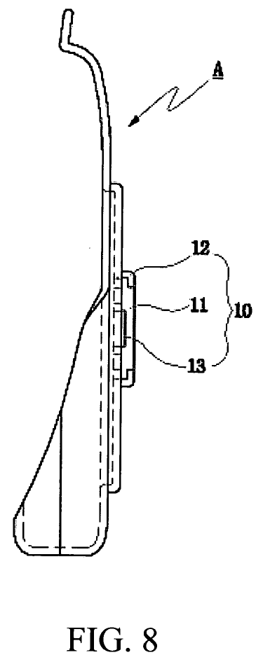

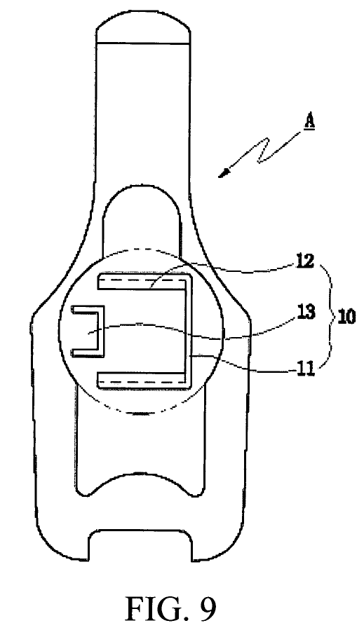

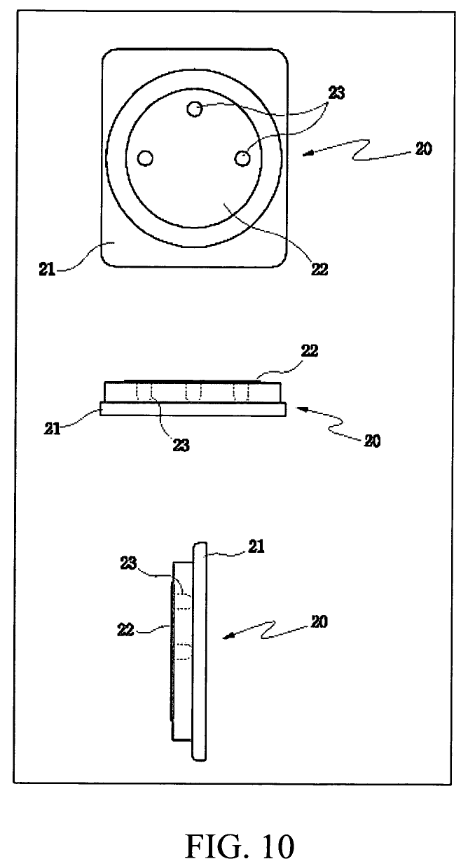

FIG. 8 is a side view illustrating a slider connecting structure integrated into a case for a mobile phone in accordance with an embodiment of the present invention. FIG. 9 is a rear view of the case in FIG. 8. FIG. 10 illustrates a plan, front and side view of a slider plate in accordance with an embodiment of the present invention.

The slider 20 is fitted into the slider rack 12 of the slider connecting structure 10 so that the elastic stopper 13 prevents the slider 20 from being detached from the slider rack 12. Further, the circular plate 22 of the slider 20 is welded to the clip retaining member 40 at a high frequency while insertion protrusions 41 are fitted into the insertion holes 23 of the circular plate 22 to permanently attach the clip 100 to the slider 20. Thus, the slider 20 can be detached from the slider connection 10 if the clip 100 needs to be removed.

Two examples of the slider connection 10 are shown in embodiments of the present invention. First, as shown in FIG. 5, the slider connection 10 is formed integrally with the case 4 for a mobile phone by injection molding. In the alternative, as shown in FIG. 6, the slider connection 10 is formed as a separate slider plate C and then the slider plate C is permanently affixed to a case made of leather or cloth because the leather or cloth case for the mobile phone cannot be made by injection molding. For example, the slider plate C on which the slider connection 10 is formed is provided with a rivet hole 17 having a step edge 16 at the center. Then, the slider plate C is tightly affixed to the leather case through the rivet hole 17 using a rivet 18. As a result, the slider 20 can be slid into the slider rack 12 of the slider connection 10 on the slider plate C because the rivet 18 is recessed in the step edge 16 inside the rivet hole 17 of the slider plate C.

When the slider 20 is inserted into the slider rack 12 toward the limit stop 11, the backstopper 13 of the slider connection 10 pops up and holds one side of the slider 20 so as to prevent the slider 20 from easily backing out of the slider rack 12. Of course, a user can detach the slider 20 from the slider rack 12 by depressing the elastic stopper 13.

As described above, embodiments of the present invention are directed to the connection of the clip used for a mobile phone retainer. The connection of the clip according to the present invention is not limited to the aforementioned two examples of the slider connection. The connection of the clip 100 may be used for cases of various types of mobile phones, PDA or other personal products.

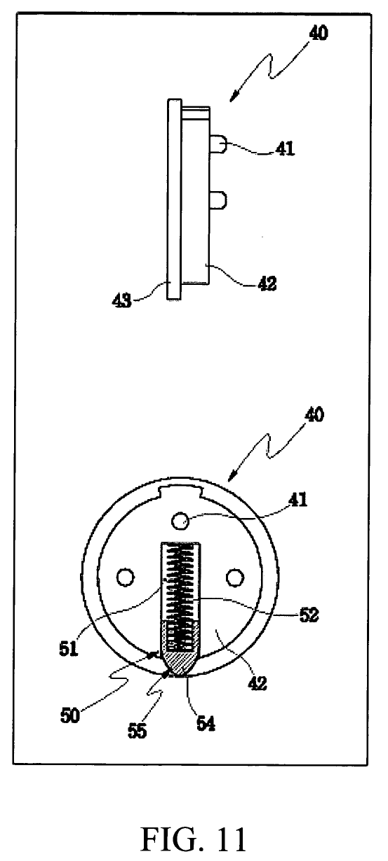

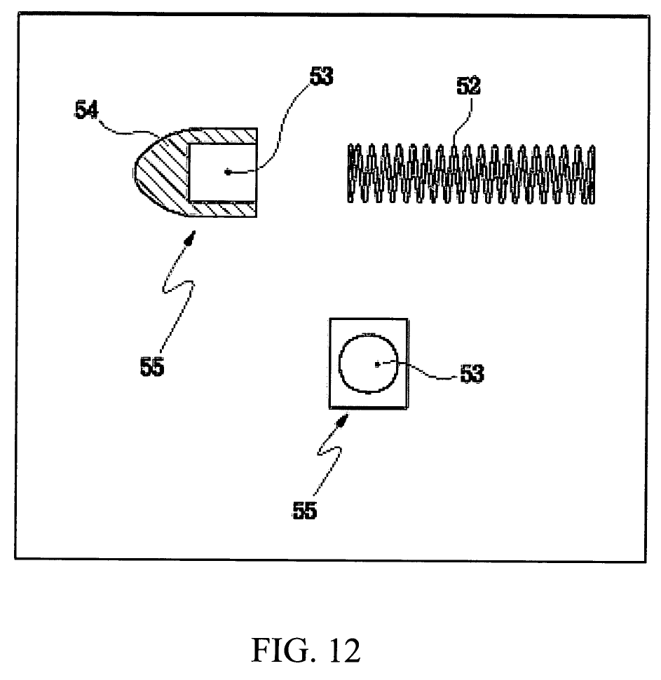

FIG. 11 illustrates a clip retaining member of the present invention, viewed from side and rear surface. FIG. 12 illustrates a cross-sectional and plan view of a ratchet pall and spring for a click portion in accordance with embodiments of the present invention. As shown in FIGS. 5, 6, 11 and 12, the spring-loaded ratchet pall 50 is provided such that the clip 100 can rotate in an indexing manner. The spring-loaded ratchet pall 50 includes a sliding groove 51, a pall 55 and an elastic spring 52. The sliding groove 51 is cut into four sections from the bottom of the circular plate 42 to its center portion. The elastic spring 52 is provided inside the sliding groove 51. The pall 55 includes an insertion hole 53 for receiving the elastic spring 52. Further, the pall 55 has a rectangular shape corresponding to the sliding groove 51 and is rounded at the end to form a ball portion 54. Therefore, when the clip 100 is rotated, the pall 55 clicks while ascending and descending along the toothed grooves 31 so as to index rotation because the pall 55 is spring-loaded against the toothed groove 31.

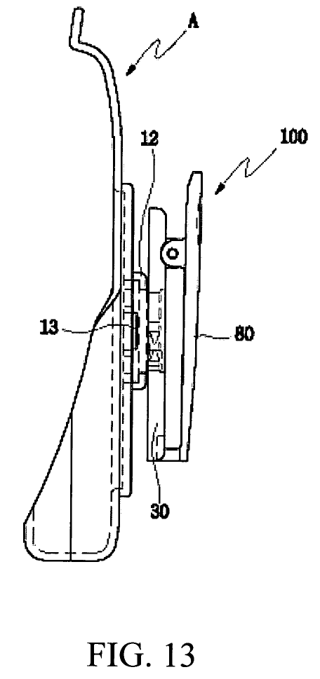

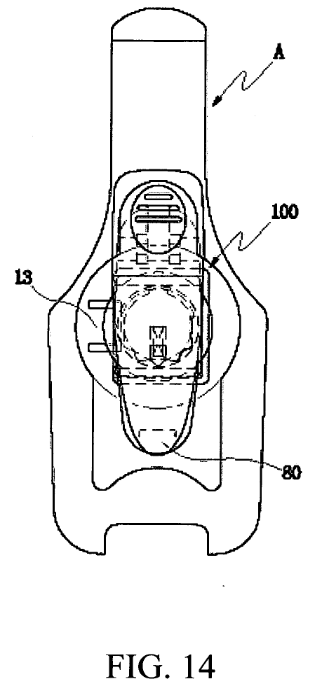

FIG. 13 is a side view illustrating a clip in accordance with an embodiment of the present invention affixed to a case for a mobile phone. FIG. 14 is a rear view of a clip in accordance with an embodiment of the present invention affixed to a case for a mobile phone. The clip 100 in embodiments of the present invention is rotated in an indexing manner using the spring-loaded pall 50. The frictional sound, such as click, of the spring-loaded pall is generated to allow a user to sense the rotational angle of the clip 100.

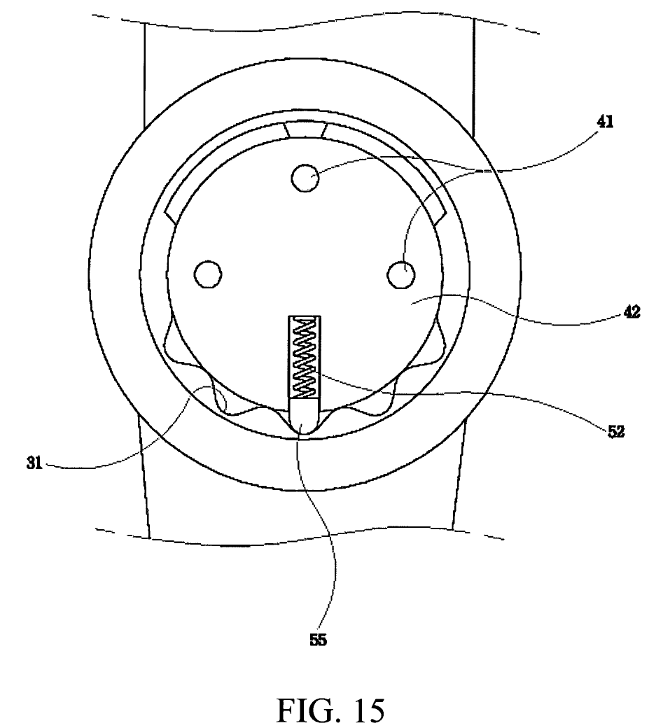

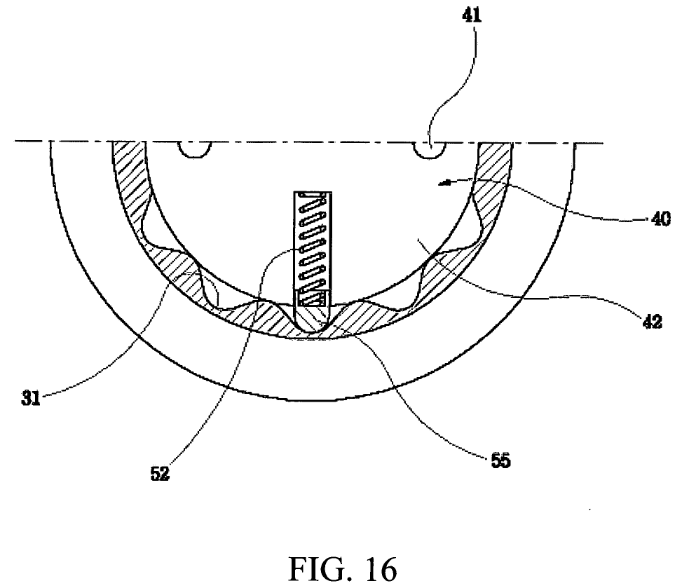

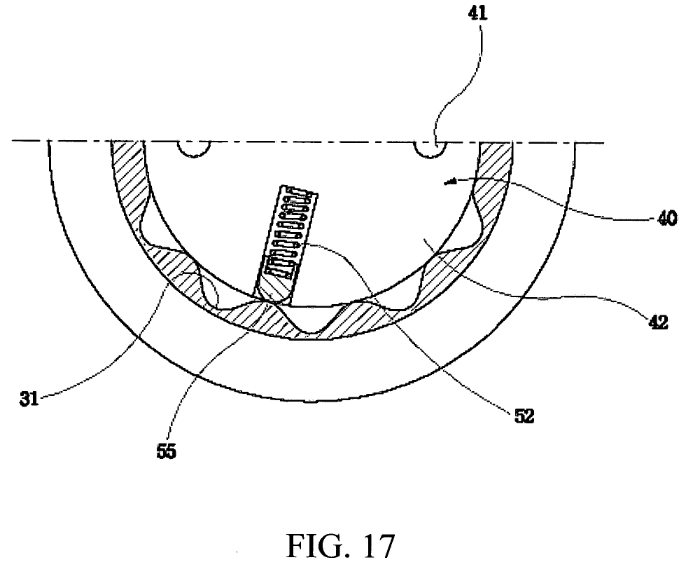

FIG. 15 is a cross-sectional view illustrating the operational of a click portion according embodiments of the present invention. FIG. 16 illustrates a ratchet pall positioned in a teeth groove in accordance with an embodiment of the present invention. FIG. 17 illustrates a ratchet pall positioned in between teeth grooves in accordance with an embodiment of the present invention. As shown in FIGS. 15 to 17, as the clip 100 is rotated, the clip retaining member 40 is affixed to the bottom plate 30 as the spring-loaded pall 50 provided in the clamp retaining member 40 rides along the toothed grooves 31 in the through hole 32. Thus, the pall 55 repeatedly comes in and out of the sliding groove 51 along the curve of the toothed grooves 31. Since the ball portion 54 provided at the end of the pall 55 is rounded along the outer circumference, the pall 55 smoothly ascends and descends along the curves of the toothed grooves 31.

A method for assembling the clip will now be described. First, as shown in FIGS. 5 and 6, the clip retaining member 40 is fitted into the through hole 32 formed at the center of the bottom plate 30 of the clip for the mobile phone. The slider 20 corresponding to the clip retaining member 40 is arranged to face the through hole 32 so that the insertion protrusions 41 are fitted into the insertion holes 23. The clamp retaining member 40 and the circular plates 42 and 22 are manufactured to have the same diameter as one another. Then, the slider 20 is welded at high frequency while the insertion protrusions 41 are fitted into the insertion holes 23 so as to adjoin the circular plates 22 and 42 with each other. Thus, the clip retaining member 40 and the slider 20 are combined into a single body by high-frequency welding. Subsequently, the top plate 80 is attached to the bottom plate 30 via a hinge 81 having a coil spring 82. The slider plate 21 of the slider 20 attached to the clip is then slid into the slider rack 12 of the slider connection 10 attached to a mobile phone retainer.

In the connecting structure of the clip and the method for assembling the clip according to embodiments of the present invention, the clip can be affixed to and later detached from the slider connection 10. In the method for assembling the clip according embodiments to the present invention, the assembling order may vary depending on types of the product or working conditions. The method for assembling a clip for a mobile phone and the connecting structure of the clip according to embodiments of the present invention has the following advantages.

Since the clip can be rotated and can detachably be fixed to the case, it is possible to clean dust that may be generated in the clip due to long use. In addition, the connecting structure of the clip is provided to easily connect or detach the clip to or from the case and other product in turn. Moreover, it is possible to replace the clip with another clip if a clip breaks.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for assembling a clip for an electronic device retainer having a slider connection, the clip including a top plate and a bottom plate, comprising:
fitting a clip retaining member into a through hole formed at the center of the bottom plate of the clip;
fitting insertion protrusions of a slider plate to corresponding insertion holes of the clip retaining member;
welding a slider and the clip retaining member together while the insertion protrusions are fitted into the insertion holes; and
connecting the top plate of the clip to the bottom plate using a hinge.

2. The method according to claim 1, further comprising:
sliding the slider into the slider connection of the electronic device retainer.

3. The method according to claim 1, wherein the slider connection includes a pair of slider racks with a limit stop at one side of and between the pair of slider racks and a backstopper provided at another side of the pair of slider racks opposite to the limit stop.

4. The method according to claim 3, wherein the backstopper is an elastic protrusion.

5. The method according to claim 3, wherein the pair of slider racks 12 has edges bent over toward each other.

6. The method according to claim 3, wherein the limit stop has an edge bent over toward the backstopper.

7. The method according to claim 1, wherein the slider connection is integrally formed in the electronic device retainer.

8. The method according to claim 1, wherein the slider includes a slider plate that fits into the slider rack of the slider connection, a circular plate protruding from a center portion of the slider plate, and the insertion holes at a front surface of the circular plate.

9. The method according to claim 1, wherein the slider connection is formed on a separate substrate that includes a rivet hole having a step edge at the center, so that the substrate is tightly affixed to the electronic device retainer using a rivet.

10. The method according to claim 1, further comprising:
inserting a spring-load pall into the clip retaining member prior to welding the slider and the clip retaining member together.

11. A connecting structure for an electronic device retainer, comprising:
a clip having a bottom plate having a hole therethrough with grooved teeth about the circumference thereof and a top plate attached to the bottom plate by a hinge;
a slider connection attached to the electronic device retainer, wherein the slider connection includes a pair of slider racks with a limit stop at one side of and between the pair of slider racks and a backstopper provided at another side of the pair of slider racks opposite to the limit edge;
a slider having a slider plate that fits into the slider rack of the slider connection; and
a clip retaining member with a spring-loaded pall in contact with the grooved teeth of the bottom plate and attached to the slider plate for connecting a clip to the mobile phone retainer such that the clip can be rotated in an indexing manner.

12. The connection structure according to claim 11, wherein the pair of slider racks has edges bent over toward each other.

13. The connection structure according to claim 11, wherein the limit stop has and edge bent over toward the backstopper.

14. The connection structure according to claim 11, wherein the slider connection is integrally formed in the mobile phone retainer.

15. The connection structure according claim 11, wherein the slider includes a slider plate that fits into the slider rack of the slider connection, a circular plate protruding from a center portion of the slider plate, and the insertion holes at a front surface of the circular plate.

16. The connection structure according to claim 11, wherein the slider connection is formed on a separate substrate from the electronic device retainer and the substrate is permanently attached to the electronic device retainer.

17. The connection structure according to claim 16, wherein the separate substrate includes a rivet hole having a step edge at the center, so that the substrate is affixed to the electronic device retainer using a rivet.

18. A connecting structure for an electronic device retainer, comprising:
a clip having a bottom plate with a guide groove and a top plate attached to the bottom plate by a hinge;
a slider connection permanently attached to the electronic device retainer, wherein the slider connection includes a pair of slider racks with a limit stop at one side of and between the pair of slider racks and a backstopper provided at another side of the pair of slider racks opposite to the limit stop;
a slider having a slider plate that fits into the slider rack of the slider connection; and
a clip retaining member having a rim edge for insertion into the guide groove of the bottom plate.

19. The connection structure according to claim 18, wherein the guide groove includes a latch and the clip retaining member includes a stopper opening at the center of the rim edge so that a latch of the guide groove can be latched within stopper opening when the rim edge is inserted into the guide groove.

20. The connection structure according to claim 18, wherein the pair of slider racks has edges bent over toward each other the limit stop has an edge bent over toward the backstopper.
